(19) United States
(12) Patent Application Publication
(10) Pub. No.: US 2010/0090970 A1
(43) Pub. Date: Apr. 15, 2010

(54) ELECTRONIC APPARATUS WITH TOUCH FUNCTION AND INPUT METHOD THEREOF

(75) Inventor: Wei-Po Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/561,258

(22) Filed: Sep. 16, 2009

(30) Foreign Application Priority Data
Oct. 9, 2008 (TW) 97138956

(51) Int. Cl. G06F 3/041

(52) U.S. Cl. 345/173

(57) ABSTRACT

An electronic apparatus with a touch function includes a screen and an input device. The input device includes a transparent plate and a signal detector. The transparent plate and the signal detector are disposed on the screen, and the signal detector is electrically coupled to the electronic apparatus through a connecting interface. The signal detector has a detecting range on the transparent plate and detects a location of a target object located within a detecting range by a non-touch detecting way to generate a first coordinate data, such that the electronic apparatus controls an operation thereof according to the first coordinate data.

### CROSS-REFERENCE TO RELATED APPLICATION

This application claims the priority benefit of Taiwan application serial no. 97138956, filed on Oct. 9, 2008. The entirety of the above-mentioned patent application is hereby incorporated by reference herein and made a part of specification.

### BACKGROUND OF THE INVENTION

1. Field of the Invention

The present invention relates to a touch panel function, and more particularly to an electronic apparatus with a touch function and an input method thereof.

2. Description of Related Art

As the industry advances day by day, digital appliances such as mobile phones, personal digital assistants (PDA), notebook computers and plane computers are all developed to be more convenient, multi-functional and pleasant looking. However, display screens in mobile phones, PDAs, notebook computers and plane computers are an indispensable human-machine communication interface. The display screens of the foregoing products can bring more convenience to users during operation, and among display screens liquid crystal display (LCD) apparatuses are the mainstream.

As information technology, wireless mobile communication and information appliances have rapidly developed and been widely applied, to achieve more convenience, more compact and light volume and more user-friendly designs, various information products have changed their conventional input devices such as key boards or mice to touch panels. Touch panel LCD apparatuses even become the most fashionable product nowadays.

However, a display apparatus having a touch panel function (e.g., notebook computers) usually requires a touch-function glass plate that is costly, and vendors also need to adhere the touch-function glass plate to the LCD panel. However, after the display apparatus is equipped with the touch-function glass plate, not only the hardware cost increases, but the weight of the notebook computer also increases. Furthermore, the touch-function glass plate cannot be detached at will.

### SUMMARY OF THE INVENTION

An electronic apparatus with a touch function and an input method thereof are provided in the present invention so that general electronic apparatuses using LCD screens are equipped with the touch function, and the fabrication cost of touch panels is lowered as well.

The electronic apparatus with the touch function includes a screen and an input device in the present invention. The input device includes a transparent plate and a signal detector. The transparent plate and the signal detector are disposed on the screen, and the signal detector is electrically coupled to the electronic apparatus through a connecting interface. The signal detector has a detecting range located on the transparent plate. The signal detector detects a location of a target object located within the detecting range by a non-touch detecting way to generate a first coordinate data. As a result, the electronic apparatus controls its own operation according to the first coordinate data.

From another aspect, the present invention provides an input method of an electronic apparatus having a screen and a transparent plate disposed on the screen. The method includes following steps. First, a detecting range is provided on the transparent plate. Whether or not a target object is located within the detecting range is detected by a non-touch detecting way. If the target object is located within, the detecting range, a first coordinate data is generated. The first coordinate data is then transmitted to the electronic apparatus through a connecting interface to operate the electronic apparatus.

The present invention has at least the following advantages. According to the present invention, an input device is used for providing a touch function. Therefore, the present invention not only provides the touch panel function to general electronic apparatuses using LCD screens, but also lowers the fabrication cost of the electronic apparatuses. Moreover, the input device of the present invention can be detached optionally to lower the weight of the electronic apparatus.

To make the above and other objectives, features, and advantages of the present invention more comprehensible, several embodiments accompanied with figures are detailed as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of an electronic apparatus according to an embodiment of the present invention.

FIG. 2 is a flowchart illustrating an input method according to an embodiment of the present invention.

FIG. 3 is a schematic view of an electronic apparatus according to another embodiment of the present invention.

### DESCRIPTION OF EMBODIMENTS

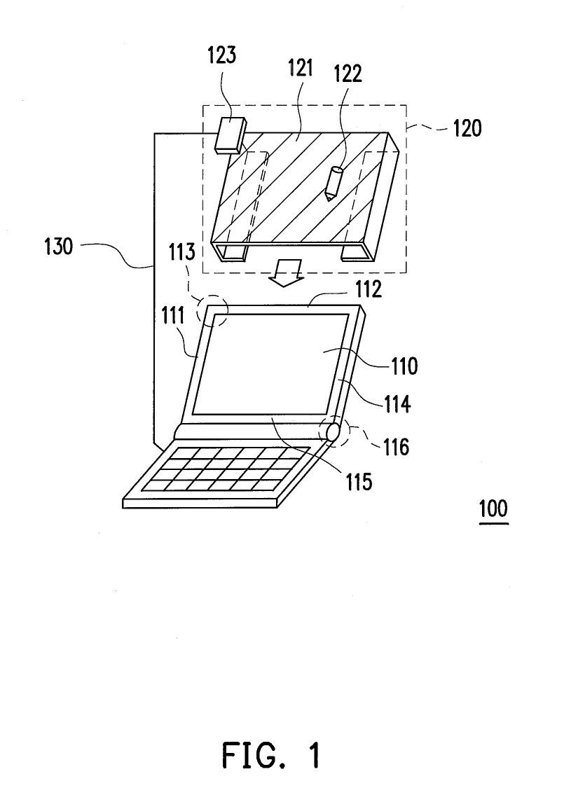

FIG. 1 is a schematic view of an electronic apparatus according to an embodiment of the present invention. According to the present embodiment, the electronic apparatus is, for example, a notebook computer, but the present invention does not limit the electronic apparatus. Referring to FIG. 1, an electronic apparatus 100 of the present embodiment includes a screen 110 and an input device 120.

According to the present embodiment, the screen 110 is a display panel, such as a liquid crystal display (LCD) panel, and used for displaying an image information. The input device 120 is disposed on the screen 110 and electrically coupled to the electronic apparatus 100 through a connecting interface 130 so that a user directly inputs on the screen 110 by handwriting (or by touch simulation) and operates the electronic apparatus 100. When the user uses the input device 120 to perform handwriting input on the screen 110, the input device 120 generates a corresponding second signal, which reflects a status the handwriting input, and the corresponding second signal is transmitted to the electronic apparatus 100 through the connecting interface 130. Afterwards, the electronic apparatus 100 generates a coordinate data correspondingly based on the second signal to determine the user's operating status.

Still referring to FIG. 1, the input device 120 includes a transparent plate 121, a handwriting pen 122 and a signal detector 123. The transparent plate 121 is disposed on the screen 110 and is an acrylic plate or a glass plate having an anti-scratch function, for example. However, the present invention does not limit the transparent plate.

According to the present embodiment, the screen 110 has a first frame 111 and a second frame 112. The first frame 111 and the second frame 112 form a first corner 113, and the signal detector 123 is disposed on the first corner 113. Additionally, the screen 110 further has a third frame 114 and a fourth frame 115. The third frame 114 and the fourth frame 115 form a second corner 116. The signal detector 123 faces the second corner 116 and is disposed on the first corner 113.

The handwriting pen 122 allows the user to input by handwriting on a surface of the transparent plate 121. The signal detector 123 is electrically coupled to the electronic apparatus 100 through the connecting interface 130 and has a detecting range on the transparent plate 121. The detecting range is an “oblique-lined section” as shown in FIG. 1.

According to the present embodiment, the signal detector 123 detects a location of a target object located within the detecting range by a non-touch detecting way to generate a first coordinate data so that the electronic apparatus 100 controls its own operation according to the first coordinate data. For example, first, the signal detector 123 emits a first signal to the detecting range, and then the handwriting pen 122 located within the detecting range reflects the first signal to form the second signal so as to generate a first coordinate data. In other words, the handwriting pen 122 touches a location on the surface of the transparent plate 121 so that the electronic apparatus 100 controls its own operation through the first coordinate data.

According to some embodiments, when the user is inputting by handwriting, such as writing or scrawling, the present invention is not limited to using the handwriting pen 122. A target object capable of reflecting the first signal may also be used. In addition, according to the present embodiment, the first signal may be an ultrasonic wave or an infrared light so that a correct location where the handwriting pen 122 touches on the surface of the transparent plate 121 is obtained from reflection of the first signal.

Moreover, the connecting interface 130 may be a universal serial bus (USB) interface or a personal system 2 (PS2) interface. In other words, when the signal detector 123 receives the second signal, the second signal is transmitted to the electronic apparatus 100 through a USB interface or a PS2 interface so that the electronic apparatus 100 analyzes the second signal to perform a corresponding operation.

In overall operation, the user may write, scrawl and so forth on the transparent plate 121 through the handwriting pen 122, for example. The signal detector 123 obtains the accurate location where the handwriting pen 122 touches on the surface of the transparent plate 121 through emitting the first signal and the second signal generated from the handwriting pen 122 reflecting the first signal. Said accurate location is the first coordinate data.

In order to obtain the accurate location where the handwriting pen 122 touches on the surface of the transparent plate 121, in the present embodiment, supposing a distance of the handwriting pen 122 from the signal detector 123 is used to determine an intensity of the second signal. For example, when the handwriting pen 122 is closer to the signal detector 123, a second signal with a stronger intensity is generated. When the handwriting pen 122 is farther from the signal detector 123, a second signal with a weaker intensity is generated. The accurate location where the handwriting pen 122 touches on the surface of the transparent plate 121 is thereby effectively obtained.

Afterwards, the signal detector 123 transmits the first coordinate data to the electronic apparatus 100 through the connecting interface 130. After the electronic apparatus 100 receives the first coordinate data, an internal program installed in the electronic apparatus 100 analyzes the first coordinate data to convert it to a second coordinate data. The internal program may also rectify the second coordinate data so that the accurate location where the handwriting pen 122 touches on the transparent plate 121 is displayed on the screen 110, and an operating system of the electronic apparatus 100 operates according to the second coordinate data.

Thus, the electronic apparatus 100 of the present embodiment has the function of a touch panel, and since the input device 120 is not adhered to the screen 110 of the electronic apparatus 100, the user may detach the input device 120 when not in use so as to reduce the weight of the electronic apparatus 100. Further, the input device 120 of the present embodiment may also simulate the function of a mouse besides carrying out the functions of writing and scrawling so as to allow the user to operate the electronic apparatus 100 more effectively.

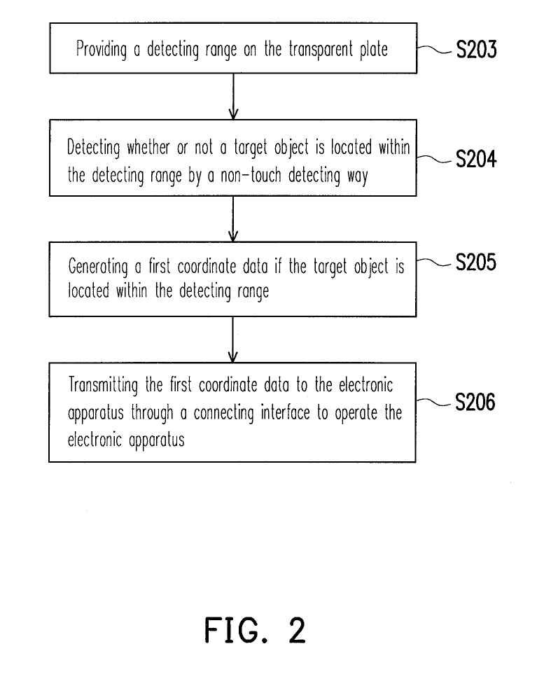

From the description of the foregoing embodiment, an input method of a touch panel is concluded as follows. FIG. 2 is a flowchart illustrating an input method according to an embodiment of the present invention. In this embodiment, an electronic apparatus has a screen and a transparent plate disposed on the screen. Referring to FIG. 2, first, as described in a step S203, a detecting range is provided on the transparent plate. For example, the signal detector 123 of FIG. 1 is used for emitting a first signal to the transparent plate 121, and the first signal is distributed on a surface of the transparent plate 121 in a radial manner.

In a step S204, whether or not a target object is located within the detecting range is detected by a non-touch detecting way. According to the present embodiment, the target object is a handwriting pen 122. For example, the user may move the handwriting pen 122 (the target object) on the surface of the transparent plate 121, i.e., an input method by handwriting. A location of the handwriting pen 122 within the detecting range is determined by the first signal emitted by the signal detector 123. According to the present embodiment, the non-touch detecting way is carried out by light detecting or sound wave detecting.

Thereafter, in a step S205, if the target object is located within the detecting range, a first coordinate data is generated. Since the handwriting pen 122 may move any time, whenever the handwriting pen 122 moves to a different location, the second signal thus generated is also different. For example, when the handwriting pen 122 is farther from the signal detector 123, the generated second signal is weaker. When the handwriting pen 122 is closer to the signal detector 123, the generated second signal is stronger. The signal detector 123 thereby effectively detects the location of the handwriting pen 122, i.e., the first coordinate data.

Then, in a step S206, the first coordinate data is transmitted to the electronic apparatus through a connecting interface to operate the electronic apparatus. In other words, the signal detector 123 transmits the first coordinate data to the electronic apparatus 100 through a connecting interface 130 so as to operate the electronic apparatus 100 according to the first coordinate data.

Moreover, a method for operating the electronic apparatus of the present embodiment further includes converting the first coordinate data to a second coordinate data so that the operating system of the electronic apparatus operates according to the second coordinate data. For example, when the signal detector 123 receives the second signal, the second signal is used for generating the first coordinate data, and the first coordinate data is transmitted to the electronic apparatus 100 through the connecting interface 130. The electronic apparatus 100 uses an internal program to analyze the first coordinate data and convert the first coordinate data to the second coordinate data correspondingly. Next, the electronic apparatus 100 determines the location where the handwriting pen 122 touches on the surface of the transparent plate 121 according to the second coordinate data. Thereafter, the electronic apparatus 100 displays the location where the handwriting pen 122 touches on the screen 110 to realize the function of the touch panel such that the operating system of the electronic apparatus 100 operates according to the second coordinate data.

According to the present embodiment, the non-touch detecting way is carried out by light detecting or sound wave detecting, but not limited thereto. In other words, the first signal may be an ultrasonic wave signal or an infrared light signal. Moreover, the transparent plate may be an acrylic plate or a glass plate. Additionally, the screen may be an LCD panel.

According to the foregoing embodiment, the input device 120 is exemplified by a combination of the transparent plate 121, the handwriting pen 122 and the signal detector 123, but the present invention is not limited thereto. Another embodiment is given for illustration below.

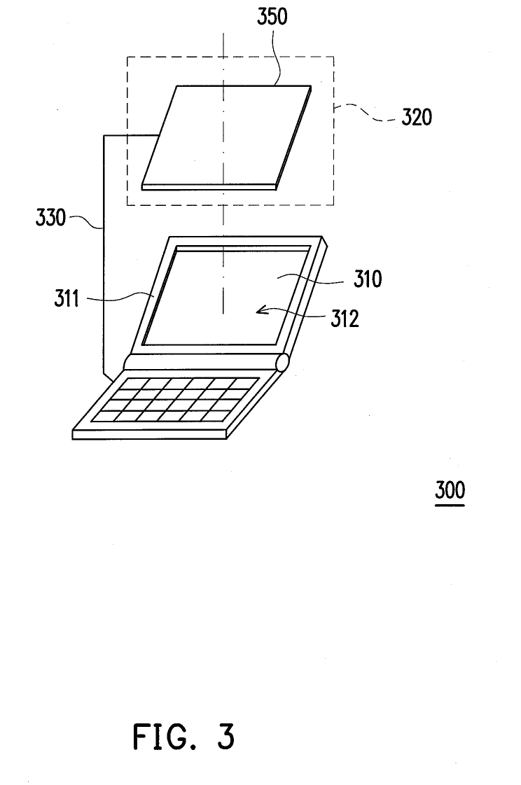

FIG. 3 is a schematic view of an electronic apparatus according to another embodiment of the present invention. Referring to FIG. 3, an electronic apparatus 300 of the present embodiment includes a screen 310 and an input device 320. The screen 310 and a frame 311 form a recessed area 312, and thus the input device 320 is disposed in the recessed area 312.

According to the present embodiment, the input device 320 may be a pressure-sensing panel 350, and the user inputs by handwriting on the pressure-sensing panel 350 to operate the electronic apparatus 300.

In overall operation, when the input device 320 detects an external force, such as a user presses the input device 320 or touches the input device 320 through a handwriting pen, the input device 320 generates correspondingly a second signal according to the sensed external force. Afterwards, the second signal is transmitted to the electronic apparatus 300 through a connecting interface 330 for the electronic apparatus 300 to analyze so that a location where the external force touches on a surface of the input device 320 is obtained. Thereafter, the electronic apparatus 300 displays the location of the external force on the screen 310 according to the coordinate data generated from the analysis so as to truly achieve the touch panel function.

In summary, according to the embodiments of the present invention, the touch panel function is achieved through the input device, i.e., the transparent plate along with the signal detector or the pressure-sensing panel. Therefore, the present invention not only provides the touch panel function for general electronic apparatuses equipped with liquid crystal screens but also lowers the fabrication cost of touch panels. Moreover, the input device of the present invention is detachable at the user's will so as to lower the weight of the electronic apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic apparatus with a touch function, comprising:
a screen; and
an input device, comprising a transparent plate and a signal detector, the transparent plate and the signal detector being detachably disposed on the screen, the signal detector being electrically coupled to the electronic apparatus through a connecting interface, the signal detector having a detecting range on the transparent plate,
wherein the signal detector detects a location of a target object within the detecting range by a non-touch detecting way to generate a first coordinate data so that the electronic apparatus controls an operation thereof according to the first coordinate data.

2. The electronic apparatus of claim 1, wherein the screen has a first frame and a second frame, the first frame and the second frame form a first corner, and the signal detector is disposed on the first corner.

3. The electronic apparatus of claim 1, wherein the signal detector outputs the first coordinate data to the electronic apparatus through the connecting interface, and the electronic apparatus converts the first coordinate data to a second coordinate data so that an operating system of the electronic apparatus operates according to the second coordinate data.

4. The electronic apparatus of claim 1, wherein the non-touch detecting way comprises emitting a first signal by the signal detector into the detecting range, and, if the target object located within the detecting range, the signal detector receives a second signal reflected from the target object to generate the first coordinate data.

5. The electronic apparatus of claim 4, wherein the first signal is an ultrasonic wave or an infrared light.

6. An input method of an electronic apparatus having a screen and a transparent plate disposed on the screen, wherein the input method comprising:
providing a detecting range on the transparent plate;
detecting whether or not a target object is located within the detecting range by a non-touch detecting way;
generating a first coordinate data if the target object is located within the detecting range; and
transmitting the first coordinate data to the electronic apparatus through a connecting interface to operate the electronic apparatus.

7. The input method of claim 6, wherein the non-touch detecting way is carried out by light detecting or sound wave detecting.

8. The input method of claim 6, wherein the transparent plate on the screen is detachable.

9. The input method of claim 6, further comprising converting the first coordinate data to a second coordinate data so that an operating system of the electronic apparatus operates according to the second coordinate data.

10. The input method of claim 6, wherein the non-touch detecting way comprising emitting a first signal into the detecting range, and, if the target object located within the detecting range, generating the first coordinate data.
